(19) United States
(12) Patent Application Publication
(10) Pub. No.: US 2012/0121868 A1
(43) Pub. Date: May 17, 2012

(54) Phthalocyanines and Their Use in Ink-Jet Printing

(75) Inventor: Prakash Patel, Manchester (GB)

(73) Assignee: Fujifilm Imaging Colorants Limited, Manchester (GB)

(21) Appl. No.: 13/377,137

(22) PCT Filed: May 26, 2010
(86) PCT No.: PCT/GB10/50870

§ 371 Date: Dec. 8, 2011

(30) Foreign Application Priority Data
Jul. 30, 2009 (GB) 0913207.7
Feb. 1, 2010 (GB) 1001542.8
Mar. 17, 2010 (GB) 1004420.4

(51) Int. Cl. C09B 47/04; B32B 3/10; B41J 2/175

(52) U.S. Cl. 428/195.1; 540/132; 8/661; 347/86

(57) ABSTRACT

A process for preparing phthalocyanine, azaphthalocyanine, metallo-phthalocyanine or metallo-azaphthalocyanine dyes and salts thereof. Also novel compounds, inks, printing processes, printed materials and ink jet cartridges.

This invention relates to compounds, compositions and inks, to printing processes, to printed substrates and to ink jet printer cartridges.

Ink jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras it is becoming increasingly common for consumers to print off photographs using an ink jet printer. This avoids the expense and inconvenience of conventional silver halide photography.

While ink jet printers have many advantages over other forms of printing and image development there are still technical challenges to be addressed. For example, there are the contradictory requirements of providing ink colorants that are soluble in the ink medium and yet display excellent wet-fastness (i.e. prints that do not run or smudge when printed). The inks also need to dry quickly to avoid printed sheets sticking together, but they should not form a crust over the tiny nozzle used in the printer. Storage stability is also important to avoid particle formation that could block the printer nozzles especially since consumers can keep an ink jet ink cartridge for several months. Furthermore, and especially important with photographic quality reproductions, the resultant images should not bronze or fade rapidly on exposure to light or common oxidising gases such as ozone. It is also important that the shade and chroma of the colorant are exactly right so that any image may be optimally reproduced.

Thus developing new colorants for ink jet printing presents a unique challenge in balancing all these conflicting and demanding properties.

The dyes, which are primarily designed for ink jet printing may also in some cases be suitable for use in the formation of color filters.

The present invention provides a process for preparing phthalocyanine, azaphthalocyanine, metallo-phthalocyanine or metallo-azaphthalocyanine dyes and salts thereof which comprises the steps of:
(a) cyclising a compound of Formula (1) with a compound of Formula (2) and optionally a compound of Formula (3) and/or Formula (4):

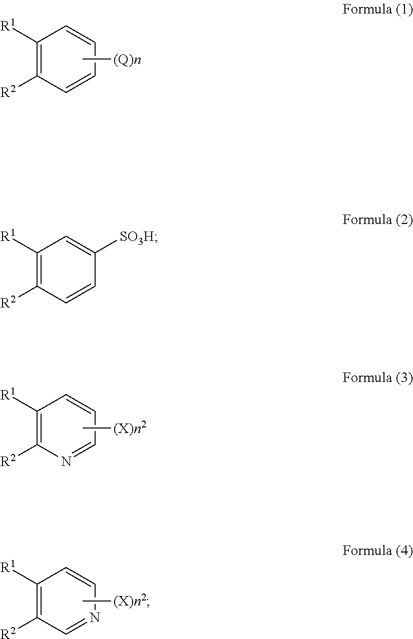

wherein:
R¹ and R² are cyano, carboxy, carboxamide or together form a group of formula:

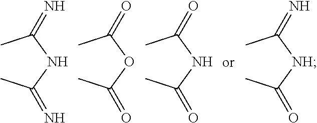

Q is an electron withdrawing group;
X is selected from the group consisting of CN, optionally substituted C₁₋₄alkyl and C₁₋₄alkoxy;
n is 1 to 4;
n² is 0 to 3; and
   wherein the cyclisation process is carried out in the presence of a suitable nitrogen source (if required) and a metal salt (if required);
(b) chlorinating the sulfonated phthalocyanines, sulfonated azaphthalocyanines, sulfonated metallo-phthalocyanines or sulfonated metallo-azaphthalocyanines formed in stage (a) with a chlorinating agent to convert the sulfonic acid substituents into sulfonyl chlorides; and
(c) reacting the phthalocyanines, azaphthalocyanines, metallo-phthalocyanines or metallo-azaphthalocyanines carrying sulfonyl chloride groups, formed in stage (b), with ammonia and/or one or more amines.

Preferably the phthalocyanine, azaphthalocyanine, metallo-phthalocyanine or metallo-azaphthalocyanine dyes and salts thereof are metallo-phthalocyanine dyes or metallo-azaphthalocyanine dyes and salts thereof and more preferably copper or nickel phthalocyanine or azaphthalocyanine dyes and salts thereof and particularly copper phthalocyanine dyes or copper azaphthalocyanine dyes and salts thereof.

Preferably R¹ and R² are cyano or carboxy, especially carboxy. More preferably R¹ and R² are the same.

Q is preferably NO₂, F or Cl, more preferably Cl.

It is preferred that n is 2 to 4, more preferably n is 4.

n² is preferably 0 or 1 and more preferably 0.

The cyclisation reaction of stage (a) is preferably carried out in any compatible solvent. Preferred solvents include ethylene glycol, diethylene glycol and sulfolane.

When a compound of Formula (1) is cyclised with a compound of Formula (2) then the preferred molar ratio of the compound of Formula (1) to that of the compound of Formula (2) is in the range of from 10/1 to 1/10. More preferably the molar ratio is in the range of 1/3 to 3/1.

When a compound of Formula (1) is cyclised with a compound of Formula (2) and a compound of Formula (3) and/or Formula (4) then the preferred molar ratio of the compound of Formula (1) to the compound of Formula (2) and the compound of Formula (3) and/or Formula (4) is in the range of 10/1/1 to 1/10/1 to 1/1/10. More preferably the molar ratio is in the range of 2/1/1 to 1/2/1 to 1/1/2. It is especially preferred that the molar ratio of the compound of Formula (1) to the compound of Formula (2) and the compound of Formula (3) and/or Formula (4) is 1/2/1

The cyclisation reaction is preferably performed at a temperature in the range of from 80-180° C., more preferably 100-150° C. and especially of from 110-130° C.

Preferably the cyclisation reaction of stage (a) is performed in the range of from 1 to 12 hours, more preferably 2 to 8 hours and especially 3 to 6 hours

The length of time for which the cyclisation reaction of stage (a) is performed depends on the temperature used. For example higher temperatures require less time and lower temperatures require more time. In a preferred embodiment cyclisation is performed at a temperature in the range of from 110-130° C. for a time in the range of from 3 to 6 hours.

In the process of the present invention, depending on the reactants and reaction conditions, it may be advantageous to incorporate a base in the cyclisation reaction. Any suitable base may be used. Preferably the base is 1,8-diazabicyclo[5.4.0]undec-7-ene (DBU).

When the product of the process is a metallo-phthalocyanine or metallo-azaphthalocyanine then a metal salt is required. Any suitable salt may be used. For example, CuCl₂ when the product of the reaction is copper phthalocyanine.

When R¹ and R² do not contain nitrogen then a source of nitrogen is required if the phthalocyanine or azaphthalocyanine ring is to be formed. Suitable sources of nitrogen include ammonia and urea.

Compounds of Formula (1), Formula (2), Formula (3) and Formula (4) may be prepared by methods well known in the art. They are also commonly commercially available.

The chlorinating agent used in stage (b) may be any suitable chlorinating agent such as, for example, chlorosulfonic acid, phosphorous pentachloride phosphorous oxychloride or phosphorous trichloride. Preferably the chlorinating agent comprises a mixture of chlorosulfonic acid and phosphorous oxychloride. Preferably the ratio of chlorosulfonic acid to phosphorous oxychloride is in the range of 25 molar equivalents to 0.5 molar equivalents and more preferably 12.5 molar equivalents to 1.0 molar equivalent.

The preferred molar ratio of the chlorinating agent to mixture of sulfonated phthalocyanine, azaphthalocyanine, metallo-phthalocyanine or metallo-azaphthalocyanine dyes obviously depends on the nature of the reactants. However when the mixture of phthalocyanine, azaphthalocyanine, metallo-phthalocyanine or metallo-azaphthalocyanine dyes is a mixture of sulfonated copper phthalocyanine dyes or copper azaphthalocyanine dyes and the chlorinating agent comprises a mixture of chlorosulfonic acid and phosphorous oxychloride then a preferred ratio of chlorinating agent to mixture of sulfonated copper phthalocyanine dyes is 100 molar equivalents to 1.0 molar equivalent and more preferably 50 molar equivalents to 1.0 molar equivalent.

Preferably chlorination is performed at a temperature in the range of from 90-180° C., more preferably 120-150° C., especially 130-148° C. and more especially 135-145° C.

Preferably the chlorination is performed for 0.5 to 16 hours, more preferably 1 to 8 hours and especially 1.5 to 5 hours.

The length of time for which the chlorination is performed depends on the temperature used. For example higher temperatures require less time and lower temperatures require more time. In a preferred embodiment chlorination is performed at a temperature of 135-145° C. for a time of from 1.5 to 8 hours and more preferably of from 2 to 7 hours.

Condensation of the product of stage (b) with ammonia and/or one or more amines in stage (c) is preferably performed at a temperature of from 10-80° C., and more preferably at a temperature of from 20-60° C. for a time of from 1 to 14 hours and more preferably of from 2 to 6 hours. The reactions with ammonia and the amine(s) can be carried out sequentially though preferably in stage (c) the mixture of phthalocyanine, azaphthalocyanine, metallo-phthalocyanine or metallo-azaphthalocyanines carrying sulfonyl chloride groups is reacted with ammonia and/or amine(s) at the same time.

The amine reacted with the mixture of phthalocyanine, azaphthalocyanine, metallo-phthalocyanine or metallo-azaphthalocyanines carrying sulfonyl chloride groups in stage (c) may be any amine able to react with a sulfonyl chloride to yield a sulfonamide.

Preferably the amine(s) is/are of Formula (5) and Formula (6)

NHR³R⁴ Formula (5)

NHR⁵R⁶ Formula (6)

wherein:
R³ and R⁴ are selected from the group consisting of H, optionally substituted alkyl (optionally interrupted by one or more hetero atoms); optionally substituted aryl; and optionally substituted heterocyclylene (including optionally substituted heteroaryl); and
R⁵ and R⁶ are selected from the group consisting of optionally substituted alkyl (optionally interrupted by one or more hetero atoms); optionally substituted aryl; and optionally substituted heterocyclylene (including optionally substituted heteroaryl).

More preferably R³ and R⁴ are selected from the group consisting of H and optionally substituted C₁₋₈alkyl, especially C₁₋₈alkyl carrying one or more water solubilising groups selected from the group consisting of —OH, —SO₃H, —CO₂H and —PO₃H₂.

It is especially preferred that R³ and R⁴ are H or optionally substituted C₁₋₄alkyl, more especially that R³ and R⁴ are independently H or unsubstituted C₁₋₄alkyl, particularly methyl.

Preferably the amine of Formula (5) carries either directly or on a substituent a water solubilising groups selected from the group consisting of —SO₃H, —CO₂H and —PO₃H₂.

A preferred amine of Formula (6) is of Formula (7):

NHR⁷-L-NR⁸R⁹ Formula (7)

wherein:
L is a divalent linking group;
R⁷ is H or optionally substituted alkyl;
R⁸ and R⁹ are independently H, optionally substituted alkyl (optionally interrupted by one or more hetero atoms), optionally substituted aryl or optionally substituted heterocyclyl.

Preferably L, the divalent linking group, is selected from the group consisting of: optionally substituted alkylene (optionally interrupted by one or more hetero atoms); optionally substituted arylene; and optionally substituted heterocyclylene (including optionally substituted heteroarylene).

More preferably L is optionally substituted alkylene, especially optionally substituted C₁₋₄alkylene, more especially unsubstituted C₁₋₄alkylene and particularly —CH₂CH₂—.

Preferably R⁷ is H or optionally substituted C₁₋₄alkyl, more preferably H, methyl or ethyl, especially H or methyl and more especially H.

Preferably R⁸ and R⁹ are independently H, optionally substituted C₁₋₄alkyl or optionally substituted heterocyclyl.

Preferably R⁸ is H or optionally substituted C₁₋₄alkyl, more preferably H, methyl or ethyl, especially H or methyl and more especially H.

Preferably R⁹ is an optionally substituted triazinyl group (where preferably the triazinyl group or substituent thereon carries at least one water solubilising group selected from the group consisting of —SO₃H, —CO₂H and —PO₃H₂).

More preferably R⁹ is a group of Formula (8)

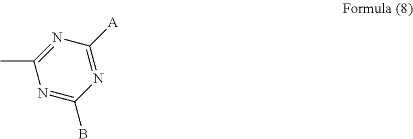

wherein:
A is selected from the group consisting of —OR¹⁰, —NR¹⁰, —NR¹⁰R¹¹;
B is selected from the group consisting of —OR¹², —SR¹², —NR¹²R¹³;
R¹⁰, R¹¹, R¹² and R¹³ are independently H, optionally substituted alkyl, optionally substituted aryl or optionally substituted heterocyclyl provided that at least one of the groups represented by R¹⁰, R¹¹, R¹² and R¹³ carries at least one substituent selected from the group consisting of —SO₃H, —CO₂H and —PO₃H₂.

Preferred groups represented by A and B may be independently selected from the group consisting of —OH, —NHCH₃, —N(CH₃)₂, —NHC₂H₄SO₃H₂, —N(CH₃)C₂H₄SO₃H₂, —NC₃H₆SO₃H, —NHdisulfophenyl, —NHsulfophenyl, —NHcarboxyphenyl or —NHdicarboxyphenyl, —N Hsulfonaphthyl, —NHdisulfonaphthyl, —NHtrisulfonaphthyl, —NHcarboxyonaphthyl, NHdicarboxyonaphthyl, NHtricarboxyonaphthyl-NHsulfoheterocyclyl, —NHdisulfoheterocyclyl or —NHtrisulfoheterocyclyl.

It is especially preferred that R⁹ is a group of Formula (9)

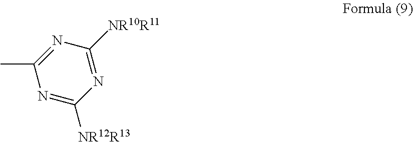

wherein:
R¹⁰ is H or optionally substituted C₁₋₄alkyl;
R¹¹ is H or optionally substituted C₁₋₄alkyl;
R¹² is H or optionally substituted C₁₋₄alkyl;
R¹³ is optionally substituted alkyl, optionally substituted aryl or optionally substituted heterocyclyl carrying at least one substituent selected from the group consisting of —SO₃H, —CO₂H and —PO₃H₂.

Preferably R¹⁰ is H or unsubstituted C₁₋₄alkyl, more preferably R¹⁰ is H or methyl, especially H.

Preferably R¹¹ is H or unsubstituted C₁₋₄alkyl, more preferably R¹¹ is H or methyl, especially H.

Preferably R¹² is H or unsubstituted C₁₋₄alkyl, more preferably R¹² is H or methyl, especially H.

In a preferred embodiment R¹⁰R¹¹ and R¹² are all independently either H or methyl, more preferably R¹⁰, R¹¹ and R¹² are all H.

Preferably R¹³ is optionally substituted aryl carrying at least one substituent selected from the group consisting of —SO₃H, —CO₂H and —PO₃H₂. More preferably R¹³ is an aryl group (particularly a phenyl group) carrying 1-3, especially 2, —SO₃H or —CO₂H groups.

Preferred optional substituents which may be present on any one of L, R³, R⁴, R⁵, R⁶, R⁷, R⁸, R⁹, R¹⁰, R¹¹, R¹² and R¹³ are independently selected from:

optionally substituted alkoxy (preferably C₁₋₄-alkoxy), optionally substituted aryl (preferably phenyl), optionally substituted aryloxy (preferably phenoxy), optionally substituted heterocyclyl, polyalkylene oxide (preferably polyethylene oxide or polypropylene oxide), phosphato, nitro, cyano, halo, ureido, hydroxy, ester, —NR^{a}R^{b}, —COR^{a}, —CONR^{a}R^{b}, —NHCOR^{a}, carboxyester, sulfone, and —SO₂NR^{a}R^{b}, wherein R^{a} and R^{b} are each independently H, optionally substituted alkyl (especially C₁₋₄-alkyl), optionally substituted aryl or optionally substituted heteroaryl. If L, R³, R⁴, R⁵, R⁶, R⁷, R⁸, R⁹, R¹⁰, R¹¹, R¹² and R¹³ comprise a cyclic group then the cyclic group may also carry an optionally substituted alkyl (especially C₁₋₄-alkyl) substituent. Optional substituents for any of the substituents described for L, R³, R⁴, R⁵, R⁶, R⁷, R⁸, R⁹, R¹⁰, R¹¹, R¹² and R¹³ may be selected from the same list of substituents.

A skilled person will appreciate that the phthalocyanine, azaphthalocyanine, metallo-phthalocyanine or metallo-azaphthalocyanine dyes and salts thereof which are the product of these reactions will be a highly disperse mixture containing isomers which vary depending on the nature and relative positions of the component rings, and the nature and position of any substituents on these component rings.

A second aspect of the invention provides phthalocyanine, azaphthalocyanine, metallo-phthalocyanine or metallo-azaphthalocyanine dyes and salts thereof obtainable by means of a process according to the first aspect of the invention.

Preferences are as described and preferred in the first aspect of the invention.

A third aspect of the present invention provides metallo-phthalocyanine dyes and salts thereof of Formula (10):

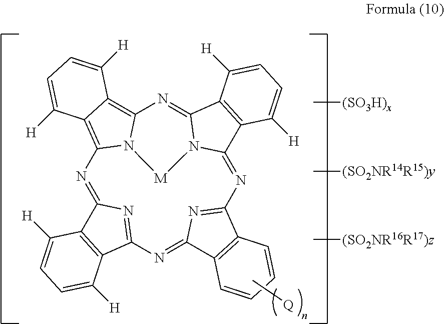

wherein
M is Ni or Cu;
R¹⁴, R¹⁵ and R¹⁶ are independently selected from the group consisting of H, optionally substituted alkyl (optionally substituted by one or more hetero atoms); optionally substituted aryl; and optionally substituted heterocyclylene (including optionally substituted heteroaryl;
R¹⁷ is optionally substituted alkyl (optionally substituted by one or more hetero atoms); optionally substituted aryl; and optionally substituted heterocyclylene (including optionally substituted heteroaryl;
Q is an electron withdrawing group;
n is 1 to 4;
x is 0to 4;
y is 0 to 4;
z is greater than 0 and less than 4; and
x+y+z is greater than 0 and less than 4.
R¹⁴, R¹⁵ and R¹⁶ are preferably independently H or optionally substituted C₁₋₄alkyl, more especially that R¹⁴, R¹⁵ and R¹⁶ are independently H or unsubstituted C₁₋₄alkyl, particularly methyl. It is especially preferred that R¹⁴, R¹⁵ and R¹⁶ are all H.
R¹⁷ is preferably a group of Formula (11):

-L-NR⁸R⁹ Formula (11)

wherein:
L is a divalent linking group;
R⁸ and R⁹ are independently H, optionally substituted alkyl (optionally interrupted by one or more hetero atoms), optionally substituted aryl or optionally substituted heterocyclyl.
L, R⁸ and R⁹ are as preferred in the first aspect of the invention.

Preferred optional substituents for R¹⁴, R¹⁵, R¹⁶ and R¹⁷ are as described above in the first aspect of the invention.

The dyes of the third aspect of the invention are preferably obtainable by a process as described in the first aspect of the invention they will therefore be a disperse mixture and so the values of y and z will be an average rather number than an integer.

Preferably y is in the range of from 1 to 3.

Preferably z is in the range of from 1 to 3.

Preferably y+z is in the range of from 1 to 3.

A fourth aspect of the present invention provides metallo-azaphthalocyanine dyes and salts thereof of Formula (12) and/or Formula (13):

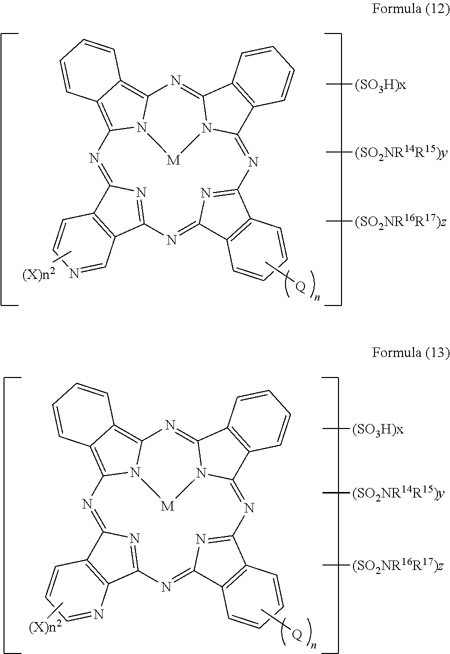

wherein
M is Ni or Cu;
R¹⁴, R¹⁵ and R¹⁶ are independently selected from the group consisting of H, optionally substituted alkyl (optionally substituted by one or more hetero atoms); optionally substituted aryl; and optionally substituted heterocyclylene (including optionally substituted heteroaryl;
R¹⁷ is optionally substituted alkyl (optionally substituted by one or more hetero atoms); optionally substituted aryl; and optionally substituted heterocyclylene (including optionally substituted heteroaryl;
Q is an electron withdrawing group;
X is selected from the group consisting of CN, optionally substituted C₁₋₄alkyl and C₁₋₄alkoxy;
n is 1 to 4;
n² is 0 to 3;
x is 0 to 4;
y is 0 to 4;
z is greater than 0 and less than 4; and
x+y+z is greater than 0 and less than 4.

Preferences for M, R¹⁴, R¹⁵, R¹⁶, R¹⁷, Q, X, n, n², x, y and z are as preferred above.

The dyes of the fourth aspect of the invention are preferably obtainable by a process as described in the first aspect of the invention they will therefore be a disperse mixture and so the values of x, y and z will be an average rather number than an integer

The dyes of the present invention have attractive, strong shades and are valuable colorants for use in the preparation of cyan ink jet printing inks. They benefit from a good balance of solubility, storage stability and fastness to water, ozone and light. In particular they display excellent wet fastness, light fastness and ozone fastness.

Acid or basic groups on the compounds disclosed in this invention, particularly acid groups, are preferably in the form of a salt. Thus, all Formulae shown herein include the compounds in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts. The mixtures of phthalocyanine or metallo-phthalocyanine dyes may be converted into a salt using known techniques.

Compounds disclosed in this specification may exist in tautomeric forms other than those shown. These tautomers are included within the scope of the present invention.

According to a fifth aspect of the present invention there is provided a composition comprising dyes as described in the second, third and fourth aspects of the invention and a liquid medium.

Preferred compositions according to the fifth aspect of the invention comprise:
(a) from 0.01 to 30 parts of dyes as described in the second, third and fourth aspects of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink jet printer as a high concentration cyan ink, a low concentration cyan ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethylene glycol monoallyl ether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethylene glycol, thiodiglycol, diethylene glycol and triethylene glycol; and mono-C₁₋₄-alkyl and C₁₋₄-alkyl ethers of diols, more preferably mono- C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189, U.S. Pat. No. 4,703,113, U.S. Pat. No. 4,626,284 and EP-A-425,150.

When the liquid medium comprises organic solvent free from water, (i.e. less than 1% water by weight) the solvent preferably has a boiling point of from 30-200° C., more preferably of from 40-150° C., especially from 50-125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the mixture of phthalocyanine dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties.

It is preferred that the composition according to the invention is ink suitable for use in an ink jet printer. Ink suitable for use in an ink jet printer is ink which is able to repeatedly fire through an ink jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink jet printer preferably has a viscosity of less than 20 cP, more preferably less than 10 cP, especially less than 5 cP, at 25° C.

Ink suitable for use in an ink jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colorant or additive incorporated in the ink).

Preferably ink suitable for use in an ink jet printer has been filtered through a filter having a mean pore size below 10 μm, more preferably below 3 μm, especially below 2 μm, more especially below 1 μm. This filtration removes particulate matter that could otherwise block the fine nozzles found in many ink jet printers.

Preferably ink suitable for use in an ink jet printer contains less than 500 ppm, more preferably less than 250 ppm, especially less than 100 ppm, more especially less than 10 ppm in total of halide ions.

If the composition according to the fifth aspect of the invention is to be used in forming film coatings, particularly in the manufacture a color filter, then it preferably further comprises a film-forming material.

Film forming inks may also comprise radical scavengers and/or UV absorbers to help improve light and heat fastness of the ink and resultant color filter.

A sixth aspect of the invention provides a process for forming an image on a substrate comprising applying a composition, preferably ink suitable for use in an ink jet printer, according to the fifth aspect of the invention, thereto by means of an ink jet printer.

The ink jet printer preferably applies the ink to the substrate in the form of droplets that are ejected through a small orifice onto the substrate. Preferred ink jet printers are piezoelectric ink jet printers and thermal ink jet printers. In thermal ink jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink jet printers the oscillation of a small crystal causes ejection of the ink from the orifice. Alternately the ink can be ejected by an electromechanical actuator connected to a moveable paddle or plunger.

The substrate is preferably paper, plastic, a textile, metal or glass, more preferably paper, an overhead projector slide or a textile material, especially paper.

Preferred papers are plain or treated papers which may have an acid, alkaline or neutral character. Photographic quality papers are especially preferred.

A seventh aspect of the present invention provides a material preferably paper, plastic, a textile, metal or glass, more preferably paper, an overhead projector slide or a textile material, especially paper more especially plain, coated or treated papers printed with phthalocyanine, azaphthalocyanine, metallo-phthalocyanine or metallo-azaphthalocyanine dyes and salts thereof as described herein, a composition according to the fifth aspect of the invention or by means of a process according to the sixth aspect of the invention.

It is especially preferred that the printed material of the seventh aspect of the invention is a print on a photographic quality paper printed using a process according to the sixth aspect of the invention.

A final aspect of the present invention provides an ink jet printer cartridge comprising a chamber and a composition, preferably ink suitable for use in an ink jet printer, wherein the composition is in the chamber and the composition is as defined and preferred in the fifth aspect of the present invention. The cartridge may contain a high concentration ink and a low concentration ink, as described in the fifth aspect of the invention, in different chambers.

The invention is further illustrated by the following Examples in which all parts and percentages are by weight unless otherwise stated.

### EXAMPLE 1

### Process Example: Preparation of a Mixture of Phthalocyanine Dyes Comprising as a Component Dyes of Formula:

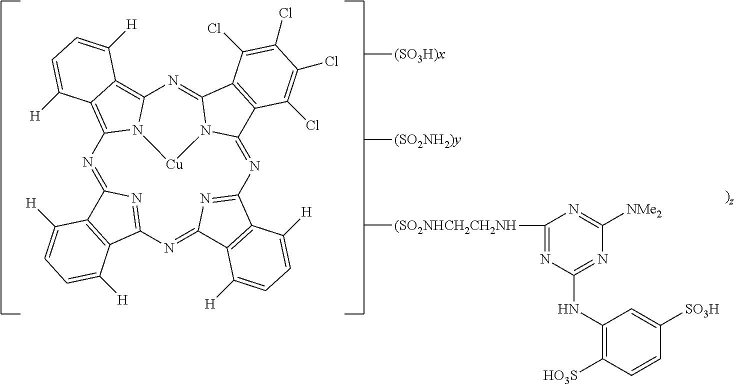

wherein x+y+z=3

### Preparation of the Intermediate Amine:

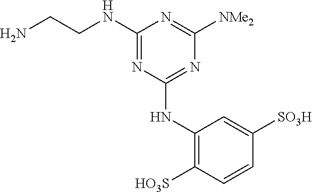

Cyanuric chloride (9.23 g) was stirred in ice/water (2000 g) containing a few drops of calsolene oil at 0-5° C. A solution of 2,5-disulfoaniline (13.8 g) in water (50 ml) at pH 5 to 6 was then added drop wise with stirring. The reaction mixture was stirred at ≦5° C. and pH 5 to 6 for 2 hours. The pH was then raised to 7 with 2M sodium hydroxide solution and the temperature to 20-25° C. and the reaction mixture was left for 1 hour. Dimethylamine (40%, 6.3 ml) was then added and the pH was adjusted to 8.5 to 9. The reaction mixture was stirred at room temperature and pH 8.5-9 for 2 hours, then at pH 8.5-9, 60° C. for 1 hour and for a further 1 hour at 80° C. before being allowed to cool overnight. The next day ethylenediamine (33 ml) was added to the mixture and the reaction was stirred at 80° C. for a further 2 hours. The volume of the reaction mixture was reduced to 200 ml using a rotary evaporator, NaCl (20 g) was added and the pH was lowered to 1 with concentrated HCl. The precipitate which formed was collected by filtration, washed with 20% NaCl and slurried in methanol (170 ml) and water (9 ml) at 60° C. for 1 hour. The solid was then collected by filtration, washed with methanol (25 ml) and dried to give the product (18.5 g).

### Stage 1a

### Preparation of a Mixture of Intermediates Comprising as a Component a Compound of Formula:

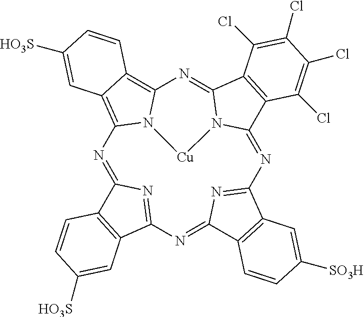

Tetrachlorophthalic acid (21.3 g), 4-sulfophthalic acid (64.05 g), copper II chloride (9.8 g), urea (168 g), DBU (10.5 g) and ammonium molybdate (1.68 g) were mixed at room temperature. The mixture was then stirred and heated to 180° C. for 1 hour. The solid reaction mixture was cooled and the product was extracted with water (3×200 ml). The resultant solution was filtered and the product was precipitated with sodium chloride. The precipitated product was filtered off, washed with 10% brine (50 ml), slurried in acetone (100 ml), filtered, washed with acetone, dried and dissolved in water. This solution was dialysed to low conductivity and dried to give the product (8.2 g).

### Stage 1b

Conversion of the Mixture of Intermediates Produced in Stage 1(a) into the Corresponding Sulfonyl Chlorides:

Phosphorous oxychloride (6.2 g) was added drop-wise to chlorosulfonic acid (60 g) over 5-10 minutes while keeping the temperature below 35° C. When all the phosphorous oxychloride had been added the compounds from Stage 1a (10 g) was added portion-wise. The temperature of the reaction mixture was gradually increased to 130° C. over 30 minutes, and the reaction was held at this temperature for 6 hours and then stirred overnight at room temperature. The next day the mixture was added to water/ice (300 g). The solid precipitate was filtered, washed with ice cold 5% brine and filtered to give 35.2 g of intermediate.

### Stage 1c

### Preparation of the Title Mixture of Phthalocyanine Dyes:

The product of stage 1b (17.6 g) in water (50 ml) was added to a mixture of the intermediate amine (2.76 g) and ammonium chloride (1.6 g) in water (50 ml) at 0-5° C. The mixture was stirred at 0-10° C. and at pH 9-9.5 for 10 minutes and then at 50° C. overnight. The pH was maintained with the addition of 2M sodium hydroxide solution. The solution was then heated at 80° C. and pH 12 for 2 hours. The reaction was cooled to 60° C. and the pH was adjusted to 8.5. The reaction was then filtered and salted out with 25% brine at pH 6. The solid which precipitated was filtered, washed with methanol, dissolved in deionised water, dialysed, filtered and then dried at 70° C. to give the product.

### EXAMPLE 2

### Prepared as in Example 1 Except that in Stage 1c 3.95 g of Intermediate Amine and 0.8 g Ammonium Chloride were Used

### EXAMPLE 3

### Process Example: Preparation of a Mixture of Phthalocyanine Dyes Comprising as a Component a Compound of Formula:

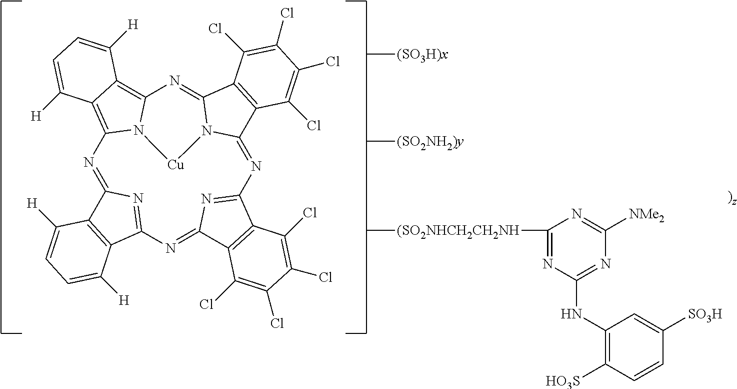

x+y+z=2

### Stage 3(a)

### Preparation of a Mixture of Intermediates Comprising as a Component a Compound of Formula:

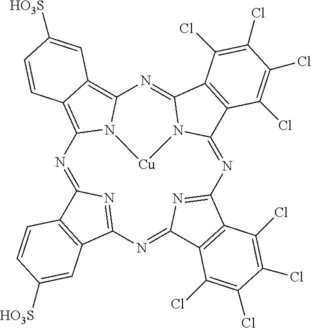

Tetrachlorophthalic acid (15.2 g), 4-sulfophthalic acid (15.8 g), copper II chloride (3.5 g), urea (60 g), DBU (3.75 g), ammonium molybdate (0.6 g) and sulfolane (50 ml) were mixed at room temperature. The mixture was then stirred and heated to 140-150° C. for 15 minutes, at 190-200° C. for 1 hour, then cooled to 80° C. Hot water (200 ml) was added and the mixture stirred at 60-80° C. for 15 minutes. The reaction mixture was filtered and washed with hot water (2×50 ml). The filtrate and washings were combined and allowed to cool to room temperature, then salted to 15% with sodium chloride at 60-70° C. The solid which precipitated was collected by filtration and washed first with 15% brine (20 ml) and then with methanol/water (150 ml/10 ml). The solid was dissolved in deionised water (150 ml), dialysed to low conductivity and dried to give the intermediate (4 g).

### Stage 3(b)

Conversion of the Mixture of Intermediates Produced in Stage 3(a) into the Corresponding Sulfonyl Chlorides:

Phosphorous oxychloride (4.5 g) was added drop-wise to chlorosulfonic acid (43.1 g) over 5-10 minutes while keeping the temperature below 35° C. When all the phosphorous oxychloride had been added the compounds from Stage 3a (7.6 g) was added portion-wise. The temperature of the reaction mixture was gradually increased to 130° C. over 30 minutes, and the reaction was held at this temperature for 6 hours and then stirred overnight at room temperature. The next day the mixture was added to water/ice (250 g). The solid precipitate was filtered, and washed with ice cold 5% brine and filtered to give 30g of intermediate.

### Stage 3c

### Preparation of the Title Mixture of Phthalocyanine Dyes:

The product of stage 3b (30 g) in water (120 ml) was added to a mixture of the intermediate amine (4 g) from Example 1 and ammonium chloride (2.28 g) in water (100 ml) at 0-5° C. The mixture was stirred at 5-10° C. and at pH 9.5 for 10 minutes and then at 40-45° C. and at pH 9-9.5 for 1 hour and then at room temperature overnight. The pH of the reaction was maintained with the addition of 2M sodium hydroxide solution. The solution was then heated at 80-85° C. and pH 12 for 1.5 hours. The reaction was cooled to 60° C. and the pH was adjusted to 8.5. The reaction was then filtered and salted out with 18% brine at pH 6 and 60° C. The solid which precipitated was filtered and washed with 20% brine (2×100 ml) to give a damp solid (38.2 g). The damp solid was slurried in methanol/water (300 ml/20 ml) at 40-50° C. for 1 hour, cooled to room temperature filtered and washed with methanol (25 ml). The solid was dissolved in deionised water (150 ml), dialysed to low conductivity, filtered and then dried at 70° C. to give the product (4.1 g)

### COMPARATIVE EXAMPLE

The comparative example was a mixture of phthalocyanine dyes comprising as a component a compound of formula:

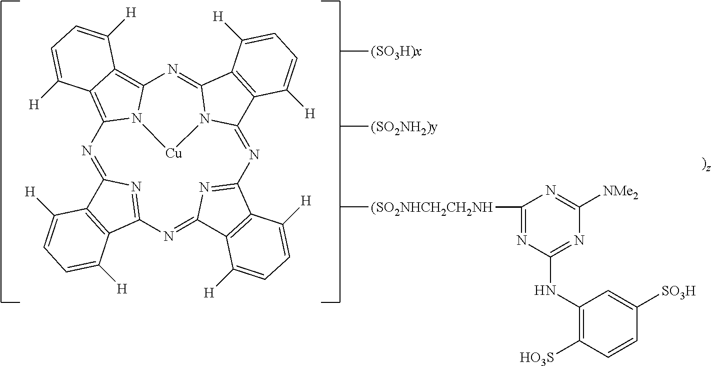

Prepared as described in Example 3 of U.S. Pat. No. 7,575,626, herein incorporated by reference.

### EXAMPLE 4

### Preparation of Inks:

Inks were prepared by dissolving 3.5 g of the dyes of Example 3 and the Comparative Example in 96.5 g of a liquid medium comprising:

| | |
|---|---|
| Diethylene glycol | 7% |
| Ethylene glycol | 7% |
| 2-Pyrollidone | 7% |
| Surfynol^{RTM} 465 | 1% |
| Tris buffer | 0.2% |
| Water | 77.8% (all % by weight) and adjusting the pH of |
| | the ink to 8-8.5 using sodium hydroxide. |

Surfynol^{RTM} 465 is a surfactant from Air Products.

### EXAMPLE 5

### Ink Jet Printing:

The ink and comparative ink prepared as described above were filtered through a 0.45 micron nylon filter and then incorporated into empty print cartridges using a syringe.

These inks were then ink-jet printed on to the following ink-jet media at 50% depth:

Epson® Ultra Premium Glossy Photo Paper (SEC PM);

Canon® Photo Paper Pro Platinum PT101 Photo Paper (PT101); and

HP Advanced Photo Paper (HPP).

The prints were tested for ozone fastness by exposure to 1 ppm ozone at 40° C., 50% relative humidity for 24 hours in a Hampden 903 Ozone cabinet. Fastness of the printed ink to ozone is judged by the difference in the optical density before and after exposure to ozone.

Light-fastness of the printed image is assessed by fading the printed image in an Atlas® Ci5000 Weatherometer for 100 hours and then measuring the change in the optical density.

Optical density measurements were performed using a Gretag® spectrolino spectrophotometer set to the following parameters:

Measuring Geometry: 0°/45°

Spectral Range: 380-730 nm

Spectral Interval: 10nm

Illuminant: D65

Observer: 2° (CIE 1931)

Density: Ansi A

External Filler: None

Light and Ozone fastness were assessed by the percentage change in the optical density of the print, where a lower figure indicates higher fastness, and the degree of fade. The degree of fade is expressed as ΔE where a lower figure indicates higher light fastness. ΔE is defined as the overall change in the CIE colour co-ordinates L, a, b of the print and is expressed by the equation ΔE=(ΔL²+Δa²+Δb²)^{0.5}.

The results are shown in the following table:

### Ozone Fastness

| | Substrate | ROD Loss | ΔE |
|---|---|---|---|
| Comparative Example | HPP | 10 | 6 |
| | PT101 | 18 | 11 |
| | SEC PM | 12 | 7 |
| Example 3 | HPP | 5 | 3 |
| | PT101 | 7 | 4 |
| | SEC PM | 5 | 3 |

### Light Fastness

| | Substrate | ROD Loss | ΔE |
|---|---|---|---|
| Comparative Example | HPP | 7 | 3 |
| | PT101 | 15 | 7 |
| | SEC PM | 6 | 5 |
| Example 3 | HPP | −8 | 4 |
| | PT101 | −9 | 5 |
| | SEC PM | 0 | 4 |

Clearly inks prepared using the dyes of the present invention display a clear advantage in light and ozone fastness.

### Further Inks

The inks described in Tables A and B may be prepared using the compound of Example 1. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink jet printing.

The following abbreviations are used in Tables A and B:

PG=propylene glycol

DEG=diethylene glycol

NMP=N-methyl pyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye Content | Water | PG | DEG | NMP | TBT | BDL | PI2 |
|---|---|---|---|---|---|---|---|
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A process for preparing phthalocyanine, azaphthalocyanine, metallo-phthalocyanine or metallo-azaphthalocyanine dyes and salts thereof which comprises the steps of:
(a) cyclising a compound of Formula (1) with a compound of Formula (2) and optionally a compound of Formula (3) and/or Formula (4): 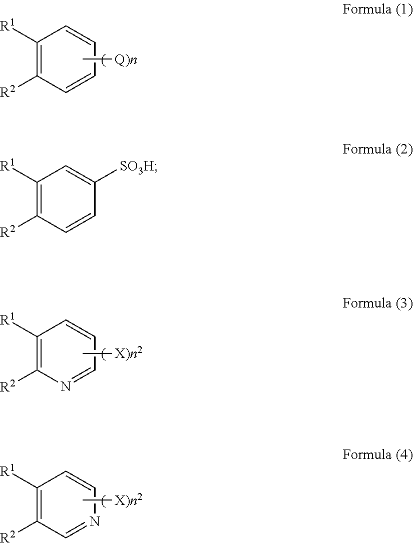
wherein:
R¹ and R² are cyano, carboxy, carboxamide or together form a group of formula 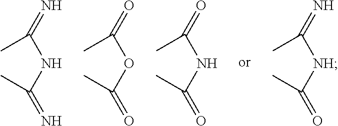
Q is NO₂, F, or Cl;
X is selected from the group consisting of CN, optionally substituted C₁₋₄alkyl and C₁₋₄alkoxy;
n is 1 to 4;
n² is 0 to 3; and
wherein the cyclisation process is carried out in the presence of a suitable nitrogen source (if required) and a metal salt (if required);
(b) chlorinating the mixture of sulfonated phthalocyanines, sulfonated azaphthalocyanines, sulfonated metallo-phthalocyanines or sulfonated metallo-azaphthalocyanines formed in stage (a) with a chlorinating agent to convert the sulfonic acid substituents into sulfonyl chlorides; and
(c) reacting the mixture of phthalocyanines, azaphthalocyanines, metallo-phthalocyanines or metallo-azaphthalocyanines carrying sulfonyl chloride groups, formed in stage (b), with ammonia and/or one or more amines.

2. A process as claimed in claim 1 wherein the metallo-phthalocyanine or metallo-azaphthalocyanine dyes are copper phthalocyanine or copper azaphthalocyanine dyes and salts thereof.

3. A process as claimed in claim 1 wherein R¹ and R² are cyano or carboxy.

4. (canceled)

5. A process as claimed in claim 1 wherein in step (b) the chlorinating agent comprises a mixture of chlorosulfonic acid and phosphorous oxychloride.

6. A process as claimed in claim 1 wherein in step (c) the amine is of Formula (7):
NHR⁷-L-NR⁸R⁹ Formula (7)
wherein:
L is a divalent linking group;
R⁷ is H or optionally substituted alkyl;
R⁸ and R⁹ are independently H, optionally substituted alkyl (optionally interrupted by one or more heterocyclic groups), optionally substituted aryl or optionally substituted heterocyclyl.

7. A process as claimed in claim 6 wherein L is —CH₂CH₂—.

8. A process as claimed in claim 6 wherein R⁹ is a group of Formula (8) 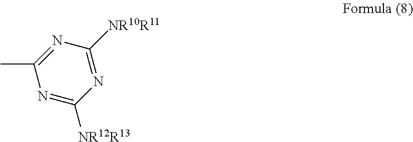
wherein:
R¹⁹ is H or optionally substituted C₁₋₄alkyl;
R¹¹ is H or optionally substituted C₁₋₄alkyl;
R¹² is H or optionally substituted C₁₋₄alkyl;
R¹³ is optionally substituted alkyl, optionally substituted aryl or optionally substituted heterocyclyl carrying at least one substituent selected from the group consisting of —SO₃H, -CO₂H and —PO₃H₂.

9. A phthalocyanine, azaphthalocyanine, metallo-phthalocyanine or metallo-azaphthalocyanine dyes and salts thereof obtainable by means of a process according to claim 1.

10. A metallo-phthalocyanine dye and salts thereof of Formula (10): 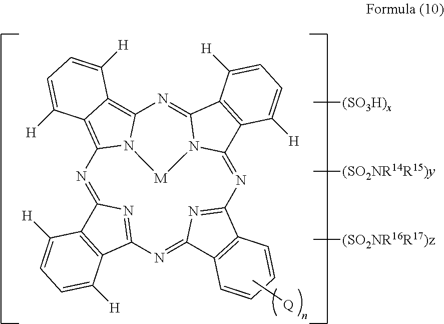
wherein
M is Ni or Cu;
R¹⁴, R¹⁵ and R¹⁶ are independently selected from the group consisting of H, optionally substituted alkyl (optionally interrupted by one or more hetero atoms); optionally substituted aryl; and optionally substituted heterocyclylene (including optionally substituted heteroaryl;
R¹⁷ is optionally substituted alkyl (optionally interrupted by one or more hetero atoms); optionally substituted aryl; and optionally substituted (including optionally substituted heteroaryl;
Q is an electron withdrawing group;
n is 1 to 4;
x is 0 to 4;
y is 0 to 4;
z is greater than 0 and less than 4; and
x+y+z is greater than 0 and less than 4.

11. A mixture of metallo-azaphthalocyanine dyes and salts thereof of Formula (12) and/or Formula (13): 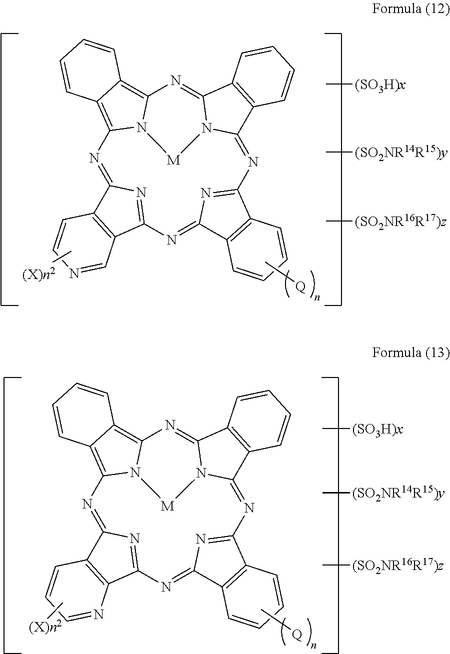
wherein
M is Ni or Cu;
R¹⁴, R¹⁵ and R¹⁶ are independently selected from the group consisting of H, optionally substituted alkyl (optionally interrupted by one or more hetero atoms); optionally substituted aryl; and optionally substituted heterocyclylene (including optionally substituted heteroaryl;
R¹⁷ is optionally substituted alkyl (optionally interrupted by one or more hetero atoms); optionally substituted aryl; and optionally substituted heterocyclylene (including optionally substituted heteroaryl;
Q is an electron withdrawing group;
X is selected from the group consisting of CN, optionally substituted C₁₋₄alkyl and C₁₋₄alkoxy;
n is 1 to 4;
n² is 0 to 3;
x is 0 to 4;
y is 0 to 4;
z is greater than 0 and less than 4; and
x+y+z is greater than 0 and less than 4.

12. A composition comprising dyes and salts thereof as described in claim 9 and a liquid medium.

13. A process for forming an image on a substrate comprising applying a composition according to claim 12 thereto by means of an ink jet printer.

14. A material printed with phthalocyanine, azaphthalocyanine, metallo-phthalocyanine or metallo-azaphthalocyanine dyes and salts thereof as described in claim 9.

15. An ink jet printer cartridge comprising a chamber and a composition, wherein the composition is in the chamber and the composition is as defined in claim 12.
